(19) United States
(12) Patent Application Publication
(10) Pub. No.: US 2009/0295377 A1
(43) Pub. Date: Dec. 3, 2009

(54) Contactless position sensor for vehicle

(76) Inventors: Daniel J. Moreno, Elpaso, TX (US); Oscar Gonzalez, El Paso, TX (US); Susan A. Maxwell, El Paso, TX (US)

Correspondence Address: DELPHI TECHNOLOGIES, INC., M/C 480-410-202, PO BOX 5052, TROY, MI, 48007, US

(21) Appl. No.: 12/156,641

(22) Filed: Jun. 3, 2008

(51) Int. Cl. G01B 7/00

(52) U.S. Cl. 324/207.23

(57) ABSTRACT

A position sensor has opposed parallel flux concentrators with a gap between them, and permanent magnets are disposed between the concentrators at the ends of the concentrators in the gap. A magnetic sense element is disposed in the gap between the magnets. The magnets with flux concentrators do not move relative to each other, and may be coupled to a moving part whose position is sought to be measured, whereas the sense element may be coupled to a stationary part.

### I. FIELD OF THE INVENTION

The present invention relates generally to contactless vehicle position sensors.

### II. BACKGROUND OF THE INVENTION

A variety of vehicle systems require knowing the angular or linear position (and/or their derivatives of angular or linear velocity) of various components. For example, in drive-by-wire systems the position of an accelerator pedal must be known to know how much fuel to inject into the engine, since mechanical linkages between the throttle and pedal may not exist. As another example, the angular position of a crankshaft, if known, can be used in distributorless ignition systems that have selectively energized ignition coils that fire the spark plugs as appropriate for the angular position of the crankshaft. Moreover, the crankshaft angular position signals can be used for combustion control and diagnostic functions.

While contact position sensors have been used, for a number of reasons contactless position sensors are preferred. Magnetic-based sensors have been introduced that use flux concentrators to increase the scope of measurement angles in rotary position sensors and to increase the scope of the linear measurement range provided by linear position sensors, and/or to augment the magnetic response of the sensor. As understood herein, such concentrators may introduce errors by developing hysteresis arising from changing magnetic flux through the concentrators.

### SUMMARY OF THE INVENTION

A sensor includes opposed first and second flux concentrators parallel to each other and spaced from each other to establish a gap therebetween. First and second permanent magnets are disposed in the gap between the concentrators substantially at first and second ends of the concentrators, and a magnetic sense element is disposed in the gap between the magnets. The magnets do not move relative to the flux concentrators, with the magnets and sense element being movable relative to each other.

The magnets with flux concentrators may establish a movable assembly couplable to a moving part whose position is sought to be measured. In contrast, the sense element can be couplable to a stationary part. Or, the magnets with flux concentrators may establish a stationary assembly couplable to a stationary part while the sense element can be couplable to a moving part.

The moving part can rotate, in which case the flux concentrators can be arcuate for at least part of their length. Or, the moving part can move linearly, in which case the flux concentrators can be elongated and substantially straight in a dimension of concentrator elongation for substantially the entire length of the concentrators.

In some embodiments the concentrators define a dimension of elongation between the first and second ends. The concentrators define a first width at the ends in a width dimension perpendicular to the dimension of elongation and a second width in the width dimension at a midpoint between the ends, with the second width being less than the first width. In other words, the concentrators taper inwardly between their respective first and second ends.

The magnets define a contour, and the contour of the concentrators can match the contour of the magnets such that substantially no part of the magnets extends beyond the contour of the concentrators. For example, the magnets can define a trapezoidal contour. The north pole of the first magnet can face the first concentrator whereas a south pole of the second magnet can face the first concentrator such that the fields provided by the magnets are opposed to each other.

In another aspect, a sensor includes opposed flux concentrators bounding opposed permanent magnets and a sense element disposed between the magnets and flux concentrators. The magnets are not movable relative to the flux concentrators but experience relative motion with the sense element.

In another aspect, a sensor has a first magnet, a second magnet, and a first flux concentrator facing the north pole of the first magnet and the south pole of the second magnet. The sensor also has a second flux concentrator stationarily supporting the magnets in cooperation with the first flux concentrator. A gap is defined between the magnets in which a sense element may be disposed to receive magnetic flux from the concentrators.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a simplified block diagram of a vehicle sensor system;

FIG. 2 is a perspective view of an embodiment of the present sensor for sensing angular position, schematically showing the rotating component and stationary component with couplings;

FIG. 3 is a plan view of the embodiment shown in FIG. 2;

FIG. 4 is a perspective view of an embodiment of the present sensor for sensing linear position, schematically showing the moving component and stationary component with couplings; and

FIG. 5 is a plan view of the embodiment shown in FIG. 4, with the end parts of the flux concentrators shown transparently to reveal the magnets.

### DETAILED DESCRIPTION OF THE PREFERRED EMBODIMENT

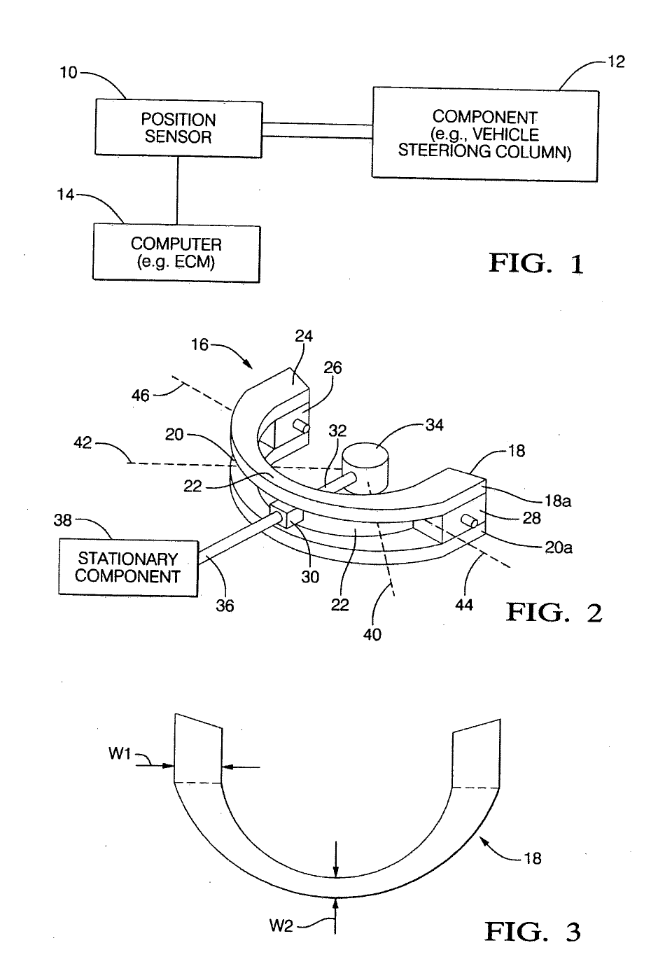

Referring initially to FIG. 1, a position sensor assembly is shown, generally designated 10, that is mechanically couplable to a moving component 12 for outputting a signal representative of the position of the moving component 12. The moving component 12 may be, without limitation, a rotating component such as a vehicle crankshaft, steering column, brake pedal shaft, accelerator shaft, engine throttle mechanism, etc. Or, the moving component 12 may be, without limitation, a linearly moving component such as a shock absorber piston, etc.

The output of the sensor assembly 10 is sent to a computer 14, such as but not limited to a vehicle engine control module. The computer 14 may use the position signal from the sensor assembly 10 for various purposes that do not delimit or define the invention. It is to be understood that the computer 14 can determine the derivative of the signal to determine velocity of the moving component 12, if desired.

FIGS. 2 and 3 show a first example 16 of the sensor assembly for sensing angular position and/or speed. As shown, the sensor assembly 16 includes first and second flux concentrators 18, 20 that are parallel to each other and that are spaced from each other to define a gap 22 therebetween. The flux concentrators may be made of a ferromagnetic material such as ferrite magnetic material, nickel iron, or silicone steel. The flux concentrators 18, 20 may be shaped substantially identically to each other as shown, and the ends 18a, 20a of the flux concentrators preferably are co-planar as shown.

In the example shown in FIGS. 2 and 3 for sensing angular position/speed, each flux concentrator 18, 20 has an arcuate mid-section 22 and opposed contoured end sections 24. Although arcuate for at least parts of their lengths, the flux concentrators 18, 20 may be thought of as elongated, and as best shown in FIG. 3 the concentrator 18 (for example) may define a first width W1 at its ends in a width dimension that perpendicular to the dimension of elongation and a second width W2 in the width dimension at a midpoint between the ends, with the second width being less than the first width. In other words, the flux concentrators may taper inwardly between their respective first and second ends.

Returning to FIG. 2, first and second permanent magnets 26, 28 are disposed between the opposed end sections 24 of the flux concentrators 18, 20. It is preferred that the north pole of one of the magnets 26, 28 face the first flux concentrator 18 while the south pole of the other magnet 28, 26 face the first flux concentrator 18 to yield a magnetic response signal that is symmetric relative to the centerline of the assembly 16. The magnets 26, 28 are immovably disposed relative to the flux concentrators 18, 20 and may be bonded or mechanically attached to the flux concentrators.

It may be appreciated in reference to FIG. 2 that the magnets 26, 28, which may be shaped identically to each other, define a contour, and the contour of the end sections 24 of the concentrators 18, 20 preferably matches the contour of the magnets such that substantially no part of the magnets extends beyond the contour of the concentrators. Indeed, as shown in FIG. 2 the sides of the end sections 24 may be co-planar with the sides of the magnets 26, 28 and likewise, the ends 18a, 20a of the concentrators 18, 20 may be co-planar with the outward-facing surfaces of the magnets 26, 28 as shown. The contour may be trapezoidal as shown in the example embodiment of FIG. 2.

At least one magnetic sense element 30 is disposed between the magnets 26, 28 in the gap 22 defined by the flux concentrators 18, 20. The magnetic sense element 30 may be a sensor of the type that generates an electrical signal that is proportional to the magnetic flux density that flows through the sense element in the dimension established by a line extending normally from one pole of the magnet 28 to the other, which may be thought of as a “z” dimension. The sense element 30, which may be, without limitation, a Hall sense element or magnetoresistive sense element, can move freely in the gap 22; thus, there may be a small space established between the concentrators 18, 20 and the sense element 30.

The concentrators 18, 20 with magnets 26, 28 may be coupled via any suitable coupling schematically shown at 32 in FIG. 2 to a rotating part 34 whose angular position and/or velocity is sought to be measured. In contrast, the sense element 30 may be coupled via any suitable coupling schematically shown at 36 in FIG. 2 to a stationary component 38. It is to be understood that the opposite couplings may be effected, i.e., that the magnets with flux concentrators are coupled to a stationary part while the sense element is coupled to the associated moving part.

In one preferred embodiment the limits of rotational motion of the rotating part 34 are shown by the dashed lines 40, 42, and the length of the gap 22, indicated by gap end lines 44, 46, may be greater than the limits of motion of the rotating part 34 to improve linearity. In addition or in the alternative a non-ferrous shim may be positioned between the magnets 26, 28 and concentrators 18, 20. The depth of the gap 22 (i.e., in the z-dimension) may be made as small as practicable relative to the size of the magnets to improve signal strength and detection range.

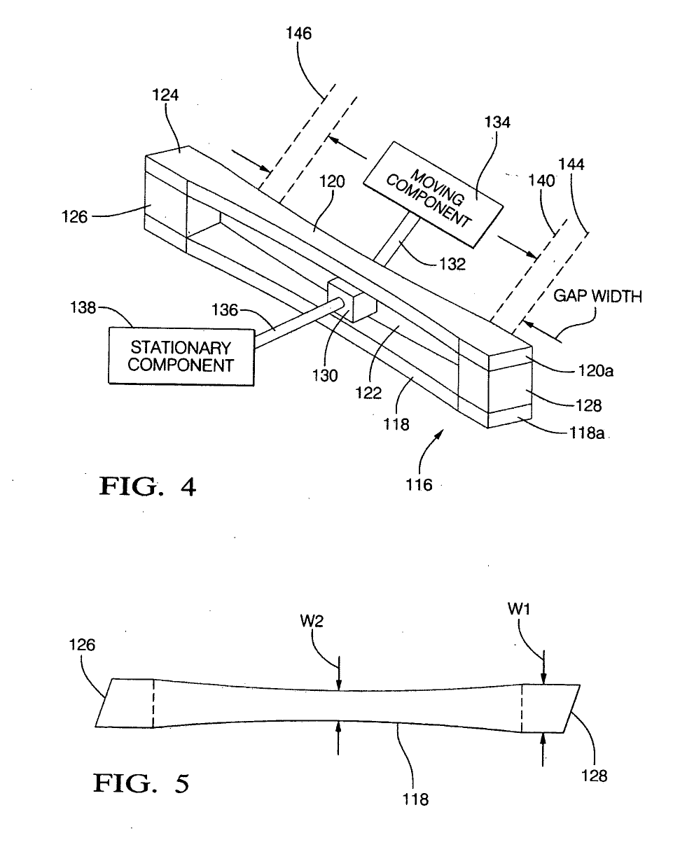

FIGS. 4 and 5 show another example sensor assembly, generally designate 116. As shown, the sensor assembly 116 includes first and second flux concentrators 118, 120 that are parallel to each other and that are spaced from each other to define a gap 122 therebetween. The flux concentrators may be made of a ferromagnetic material such as ferrite magnetic material, nickel iron, or silicone steel. The flux concentrators 118, 120 may be shaped substantially identically to each other as shown, and the ends 118a, 120a of the flux concentrators preferably are co-planar as shown.

In the example shown in FIGS. 4 and 5 for sensing linear position/speed, each flux concentrator 118, 120 has a straight mid-section 122 and opposed contoured end sections 124. The flux concentrators 118, 120 thus are elongated, and as best shown in FIG. 5 the concentrator 118 (for example) may define a first width W1 at its ends in a width dimension that perpendicular to the dimension of elongation and a second width W2 in the width dimension at a midpoint between the ends, with the second width being less than the first width. In other words, the flux concentrators may taper inwardly between their respective first and second ends.

Returning to FIG. 4, first and second permanent magnets 126, 128 are disposed between the opposed end sections 124 of the flux concentrators 118, 120. It is preferred that the north pole of one of the magnets 126, 128 face the first flux concentrator 118 while the south pole of the other magnet 128, 126 face the first flux concentrator 118 to yield a magnetic response signal that is symmetric relative to the centerline of the assembly 116. The magnets 126, 128 are immovably disposed relative to the flux concentrators 118, 120 and may be bonded or mechanically attached to the flux concentrators.

It may be appreciated in reference to FIG. 4 that the magnets 126, 128, which may be shaped identically to each other, define a contour, and the contour of the end sections 124 of the concentrators 118, 120 preferably matches the contour of the magnets such that substantially no part of the magnets extends beyond the contour of the concentrators. Indeed, as shown in FIGS. 4 and 5 the sides of the end sections 124 may be co-planar with the sides of the magnets 126, 128 and likewise, the ends 118a, 120a of the concentrators 118, 120 may be co-planar with the outward-facing surfaces of the magnets 126, 128 as shown. The contour may be trapezoidal as shown in the example embodiment of FIGS. 4 and 5.

At least one magnetic sense element 130 is disposed between the magnets 126, 128 in the gap 122 defined by the flux concentrators 118, 120. The magnetic sense element 130 may be a sensor of the type that generates an electrical signal that is proportional to the magnetic flux density that flows through the sense element in the dimension established by a line extending normally from one pole of the magnet 128 to the other, which may be thought of as a “z” dimension. The sense element 130, which may be, without limitation, a Hall sense element or magnetoresistive sense element, can move freely in the gap 122; thus, there may be a small space established between the concentrators 118, 120 and the sense element 130.

The concentrators 118, 120 with magnets 126, 128 may be coupled via any suitable coupling schematically shown at 132 in FIG. 4 to a linearly-movable part 134 whose linear position and/or velocity is sought to be measured. In contrast, the sense element 130 may be coupled via any suitable coupling schematically shown at 136 in FIG. 4 to a stationary component 138, but again, the sense element may be coupled to the moving part and the magnets coupled to the stationary part. In one preferred embodiment the limits of translational motion of the linearly-moving part 134 are shown by the dashed lines 140, 142, and the length of the gap 122, indicated by gap end lines 144, 146, may be greater than the limits of motion of the part 134 to improve linearity. In addition or in the alternative a non-ferrous shim may be positioned between the magnets 126, 128 and concentrators 118, 120. The depth of the gap 122 (i.e., in the z-dimension) may be made as small as practicable relative to the size of the magnets to improve signal strength and detection range.

While the particular CONTACTLESS POSITION SENSOR FOR VEHICLE is herein shown and described in detail, it is to be understood that the subject matter which is encompassed by the present invention is limited only by the claims.

What is claimed is:

1. A sensor, comprising:
opposed first and second flux concentrators parallel to each other and spaced from each other to establish a gap therebetween;
first and second permanent magnets disposed in the gap between the concentrators substantially at first and second ends of the concentrators; and
a magnetic sense element disposed in the gap between the magnets, the magnets not moving relative to the flux concentrators, the magnets and sense element being movable relative to each other.

2. The sensor of claim 1, wherein the magnets with flux concentrators establish a movable assembly couplable to a moving part whose position is sought to be measured, the sense element being couplable to a stationary part.

3. The sensor of claim 2, wherein the moving part rotates and the flux concentrators are arcuate for at least part of their length.

4. The sensor of claim 2, wherein the moving part moves linearly and the flux concentrators are elongated and are substantially straight in a dimension of concentrator elongation for substantially the entire length of the concentrators.

5. The sensor of claim 1, wherein the concentrators define a dimension of elongation between the first and second ends, and the concentrators define a first width at the ends in a width dimension perpendicular to the dimension of elongation and a second width in the width dimension at a midpoint between the ends, the second width being less than the first width.

6. The sensor of claim 1, wherein the magnets define a contour, and the contour of the concentrators matches the contour of the magnets such that substantially no part of the magnets extends beyond the contour of the concentrators.

7. The sensor of claim 6, wherein the magnets define a trapezoidal contour.

8. The sensor of claim 1, wherein a north pole of the first magnet faces the first concentrator and a south pole of the second magnet faces the first concentrator.

9. A sensor comprising:
opposed flux concentrators bounding opposed permanent magnets and a sense element disposed between the magnets and flux concentrators, the magnets not being movable relative to the flux concentrators, the magnets and sense element being movable relative to each other.

10. The sensor of claim 9, wherein the concentrators are first and second concentrators each defining first and second ends and the magnets are first and second magnets.

11. The sensor of claim 10, wherein the magnets with flux concentrators establish a movable assembly couplable to a moving part whose position is sought to be measured, the sense element being couplable to a stationary part.

12. The sensor of claim 11, wherein the moving part rotates and the flux concentrators are arcuate for at least part of their length.

13. The sensor of claim 11, wherein the moving part moves linearly and the flux concentrators are elongated and are substantially straight in a dimension of concentrator elongation for substantially the entire length of the concentrators.

14. The sensor of claim 9, wherein the concentrators taper inwardly between their respective first and second ends.

15. The sensor of claim 9, wherein the magnets define a contour, and the contour of the concentrators matches the contour of the magnets.

16. The sensor of claim 15, wherein the magnets define a trapezoidal contour.

17. The sensor of claim 10, wherein a north pole of the first magnet faces the first concentrator and a south pole of the second magnet faces the first concentrator.

18. A sensor comprising:
a first magnet;
a second magnet;
a first flux concentrator facing the north pole of the first magnet and the south pole of the second magnet;
a second flux concentrator stationarily supporting the magnets in cooperation with the first flux concentrator; wherein
a gap is defined between the magnets in which a sense element may be disposed to receive magnetic flux from the concentrators.

19. The sensor of claim 18, wherein the magnets with flux concentrators establish a movable assembly couplable to a moving part whose position is sought to be measured, the sense element being couplable to a stationary part, wherein the moving part rotates and the flux concentrators are arcuate for at least part of their length.

20. The sensor of claim 18, wherein the magnets with flux concentrators establish a movable assembly couplable to a moving part whose position is sought to be measured, the sense element being couplable to a stationary part, wherein the moving part moves linearly and the flux concentrators are elongated and are substantially straight in a dimension of concentrator elongation for substantially the entire length of the concentrators.
